(19) United States
(12) Patent Application Publication
(10) Pub. No.: US 2020/0380558 A1
(43) Pub. Date: Dec. 3, 2020

(54) ADVERTISEMENT DISPLAY CONTROLLER, SERVER, AND ADVERTISEMENT DISPLAY CONTROL METHOD

(71) Applicant: FANUC CORPORATION, Minamitsuru-gun (JP)

(72) Inventor: Nao ONOSE, Yamanashi (JP)

(21) Appl. No.: 16/844,209

(22) Filed: Apr. 9, 2020

(30) Foreign Application Priority Data
May 31, 2019 (JP) 2019-102999

(51) Int. Cl. G06Q 30/02; H04H 60/31

(52) U.S. Cl. CPC G06Q 30/0251; H04H 60/31; G06Q 30/0272

(57) ABSTRACT

An advertisement with. a high appealing effect is provided. depending on a use state of an industrial machine. An advertisement display controller that outputs an advertisement of a product used by an industrial machine to the industrial machine includes: an advertisement storage unit that stores data indicating an advertisement of each of a plurality of products; a state observation unit that observes a state of the industrial machine on the basis of at least a machining state of the industrial machine and a machining operation history of the industrial machine; an advertisement determination unit that selects an advertisement including information useful for a user of the industrial machine on the basis of an observation result of the state observation unit; and an advertisement output unit that outputs the advertisement selected by the advertisement determination unit to the industrial machine.

This application is based on and claims the benefit, of priority from Japanese Patent Application. No. 2019-102999, filed on 31 May 2019, the content of which is incorporated herein by reference.

### BACKGROUND OF THE INVENTION

### Field of the Invention

The present, invention relates to an advertisement, display controller, a server, and an advertisement display control method.

### Related Art

In recent years, a form of service called an industrial machine sharing service in which one industrial machine is shared and used in units of time or the number of parts to be machined has emerged.

In such a sharing service, as a method for lessening the cost burden of a user and preventing decrease in the profit of a service providing manufacturer, a technique of displaying an advertisement on a display unit of a time-rental terminal device has been proposed. For example, see Patent Document 1.

Patent Document 1: Japanese Unexamined Patent. Application, Publication No. 2019-21209

### SUMMARY OF THE INVENTION

However, in an advertisement display form in the industrial machine sharing service, a mechanism for increasing the effect of an advertisement on the basis of information such as machining direction and preference of a user and a configuration of an industrial machine is currently not present. Therefore, it is difficult to provide an advertisement with a high appealing effect for an advertisement manufacturer.

Therefore, it is desirable to provide an advertisement with a high appealing effect depending on a use state of an industrial machine.

(1) An aspect of an advertisement display controller of the present disclosure is an advertisement display controller that outputs an advertisement of a product used by an industrial machine to the industrial machine, including: an advertisement storage unit that stores data indicating an advertisement of each of a plurality of products; a state observation unit that observes a state of the industrial machine on the basis of at least a machining state of the industrial machine and a machining operation history of the industrial machine; an advertisement determination unit that selects an advertisement including information useful for a user of the industrial machine on the basis of an observation result of the state observation unit; and an advertisement output unit that outputs the advertisement selected by the advertisement determination unit to the industrial machine.

(2) An aspect of a server of the present disclosure includes the advertisement display controller according to (1).

(3) An aspect of an. advertisement display control method of the present disclosure is an advertisement display control method for outputting an advertisement of a product used by an industrial machine to the industrial machine, the method being realized by a computer and including: an advertisement storage step of storing data indicating an advertisement of each of a plurality of products; a state observation step of observing a state of the industrial machine on the basis of at least a machining state of the industrial machine and a machining operation history of the industrial machine; an advertisement determination step of selecting an advertisement including information useful for a user of the industrial machine on the basis of an observation result in the state observation step; and an advertisement output step of outputting the advertisement selected to the industrial machine.

According to an aspect, it is possible to provide an advertisement with a high appealing effect depending on a use state of an industrial machine.

### BRIEF DESCRIPTION OF TEE DRAWINGS

FIG. 1 is a diagram illustrating an example of a configuration of a machine tool according to an embodiment.

FIG. 2 a diagram illustrating an example of an advertisement of an additional function.

FIG. 3 is a diagram illustrating an example of an advertisement of a tool.

FIG. 4 is a diagram illustrating a small-scale modification of a program.

FIG. 5 is a diagram illustrating an example of an advertisement of a simulator.

FIG. 6 is a flowchart for describing an advertisement display process of an advertisement display controller.

FIG. 7 is a diagram illustrating an example of an advertisement distribution system.

### DETAILED DESCRIPTION OF THE INVENTION

Hereinafter, an embodiment will be described with reference to the drawings.

### Embodiment

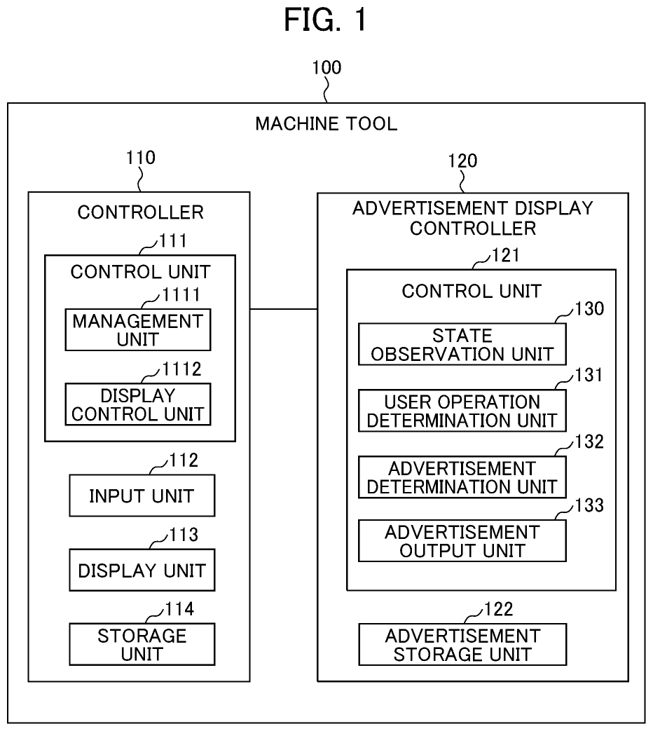

FIG. 1 is a diagram illustrating an example of a configuration of a machine tool 100 according to the present embodiment. As illustrated in FIG. 1, a machine tool 100 includes a controller 110 and an advertisement display controller 120 which are incorporated therein. The controller 110 and the advertisement display controller 120 may be devices independent from the machine tool 100. Moreover, the advertisement display controller 120 may be incorporated. in the controller 110.

The machine tool 100 is a machining machine that operates according to the numerical control of the controller 110.

The present embodiment is not limited to the machine tool 100 but can be broadly applied to industrial machines in general. An industrial machine includes various machines such as, for example, a machine tool, an industrial robot, a service robot, a forging machine, and. an injection molding machine.

The controller 110 is a numerical controller that is well known to those skilled. in the art and controls the operation. of the machine tool 100. When the machine tool 100 is a robot, the controller 110 includes a robot controller or the like.

As illustrated in FIG. 1, the controller 110 includes a control unit 111, an input unit 112, a display unit 113, and a storage unit 114.

The input unit 112 is a device used for inputting changes or corrections of a manufacturer or a product number of a part such as a tool attached. to the machine tool 100, and setting parameters of a machining program, and for example, is a keyboard or a touch panel.

The display unit 113 is a liquid crystal display or the like, for example, and displays data indicating the state of machining by the machine tool 100 and an advertisement related to an additional function of a function of the machine tool 100, an additional function. of the machine tool 100, and a product. such as a tool or consumables attached to the machine tool 100 on the basis of an instruction from a display control unit 1112 to be described later.

The storage unit 114 is a solid state drive (SSD), a hard disk drive (HDD) , or the like. The storage unit 114 may have a management storage area (not illustrated) that stores a machining state of the machine tool 100, an operation history of machining in the machine tool 100, a list of functions included in the machine tool 100, and consumable management information including use history information and product information about consumables (products) such as tools, coolants, and grindstones used in the machine tool 100.

The control unit 111 includes a central processing unit (CPU), a read only memory (ROM), a random access memory (RAM), a complementary metal-oxide semiconductor (CMOS) memory, and the like, which are communicably connected via a bus, and is well known to those skilled in the art.

The CPU is a processor that controls the entire controller 110. The CPU reads a system program and an application program stored in the ROM via the bus and controls the entire controller 110 according to the system program and the application program so that the control unit 111 realizes the functions of a management unit 1111 and the display control unit 1112 as illustrated in FIG. 1. Various pieces of data such as temporary computation data and display data are stored in the RAM. The CMOS memory is backed up by a battery (not illustrated) and is configured as a nonvolatile memory of Which. the storage state is maintained. even when. the machine tool 100 is turned off.

The management unit 1111 assigns a tool number (for example, a first tool number to an M-th tool number (M is an arbitrary natural number)) for identifying a tool to each tool used by the machine tool 100 and manages use history information (for example, a tool replacement time, an cumulative tool use time, and the like) of the tool together with product information (for example, a product name, a model, a manufacturer, the use of a tool, and the like) related to the tool. The use of a tool means whether a tool is used for machining stainless steel or aluminum, for example. The tool use history is updated appropriately according to the use of a tool. Such management is not limited to a tool, but similar management is performed on other consumables (for example, coolants, grindstones, and the like) used by the machine tool 100.

Moreover, the management unit 1111 may manage the machining state of the machine tool 100 and a machining operation history of the machine tool 100 according to a command that the controller 110 outputs to the machine tool 100 on the basis of a machining program.

When an advertisement is received by an advertisement display controller 120 to be described later, the display control unit 1112 may output the received advertisement on the display unit 113.

### <Advertisement Display Controller 120>

As illustrated in FIG. 1, the advertisement display controller 120 includes a control unit 121 and an advertisement storage unit 122.

### <Advertisement Storage Unit 122>

Before describing the function of the control unit 121, an advertisement output by the advertisement display controller 120 will be described.

An advertisement can be classified as follows depending on an advertisement target.

(1) An advertisement related to a non-purchased additional function (hereinafter also referred to as an “additional function”) among the functions of the machine tool 100.

(2) An advertisement related to consumables such as, for example, tools, coolants, and grindstones (hereinafter also referred to as consumables) used by the machine tool 100.

(3) An advertisement related to a product (hereinafter referred to as “operation efficiency improvement”) for improving the efficiency of a user's operation related to the machine tool 100.

Here, an advertisement may generally include image data such as a video and audio data.

Hereinafter, a specific description will be given according to the above-described classification.

First, “(1) additional function advertisement” will be described.

When the machine tool 100 has a tool tip point control function, for example, by combining additional functions such as a cutting point command function and a tool attitude control function, it is possible to improve the machining quality and shorten the machining time. In this manner, it is beneficial also for a user to provide an additional function that can provide more useful effects by being combined. with the functions included in. the machine tool 100 to the user and recommend an additional purchase.

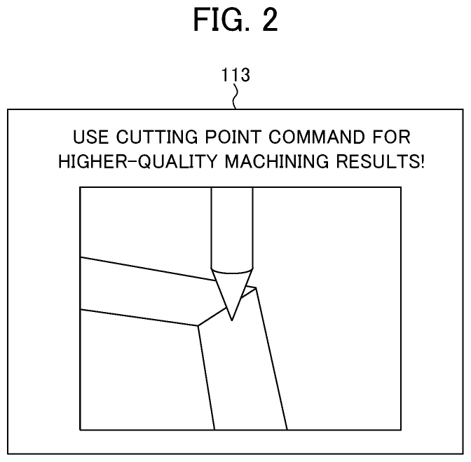

FIG. 2 is a diagram illustrating an example of an advertisement of an additional function. As illustrated in FIG. 2, for example, by displaying an advertisement of an additional function on the display unit 113 of the controller 110, it is possible to appeal the usability of the additional function to an operator of the machine tool 100.

Moreover, the advertisement may be displayed on a monitor, a mobile terminal, or the like provided near the machine tool 100, for example, without being limited to the display unit 113 of the controller 110.

As a timing to display such an additional function advertisement, it is preferable to display an advertisement during the use of the function, excluding a period in which a user such as an operator performs an operation (for example, a loading operation, a work checking operation, or the like) related to machining, for example.

A list of functions of the machine tool 100 may be acquired by referring to the storage unit 114 (a management storage area) of the machine tool 100, for example, and an advertisement related to a non-purchased additional function for each of the functions included in the machine tool 100 may be stored in advance in the advertisement storage unit 122. Moreover, data (hereinafter, “advertisement display timing data”) related to a timing (or a timing to suppress display of the advertisement) to display the advertisement may be set in advance so as to correspond to the advertisement of each additional function. By doing so, an advertisement determination unit 132 to be described later can display an advertisement related to an additional function at an appropriate timing by referring to the advertisement storage unit 122.

Next, “(2) consumable advertisement” will be described. The machine tool 100 performs machining of a work using a tool, for example, as is well known. The machine tool 100 assigns a tool number (for example, a first tool number to an N-th tool number) for identifying a of to each tool being used and manages product information (for example, a product name, a model, a manufacturer, the use of a tool, and the like) related to the tool and use history information (for example, a tool replacement tame, an cumulative tool use time, and the like) of the tool.

Each tool has a tool lifetime which is a period for which the tool can be used for machining after the tool is replaced. Therefore, a tool is requested to be replaced with a new tool when the cumulative tool use time exceeds a predetermined period.

Such management is not limited to a tool. Similar management may be performed on other consumables (for example, coolants, grindstones, and the like) used by the machine tool 100.

For such consumables, advertising a new product, for example, at a timing of replacing a consumable has a certain effect.

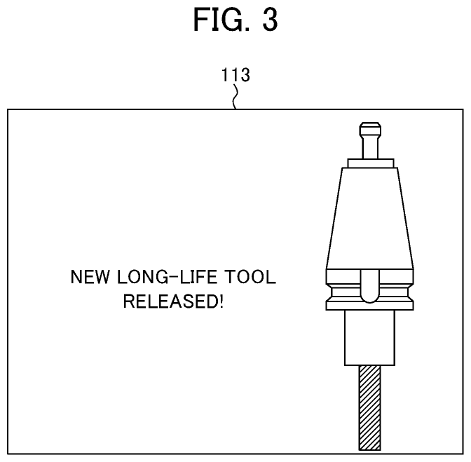

Therefore, the advertisement storage unit 122 may store an advertisement related to a follow-up product or a new product for the product on the basis of product information (for example, a model) for each consumable with respect to the consumables (for example, tools) being used by the machine tool 100. When a follow-up product or a new product for the product is not present, such a product may be regarded as a non-advertisement target. FIG. 3 is a diagram illustrating an advertisement of a tool as an example of a consumable. As illustrated in FIG. 3, for example, by displaying an advertisement of a tool on the display unit 113 of the controller 110, it is possible to appeal the usability of a new product tool to the operator of the machine tool 100.

As a timing to display such a consumable advertisement, it is possible to determine which consumable has reached. its lifetime for each consumable (for example, for each tool number) by referring to the consumable management information of the machine tool 100, for example. Therefore, it is useful to provide a new product advertisement corresponding to a consumable having reached its lifetime prior to a period in. which tool replacement is performed. by taking a period. required for delivery from placement of an order into consideration. It is further useful to provide a one-touch operation function with which it is possible to easily place an order for an advertisement product in an advertisement screen.

As a timing of these consumable advertisements, is desirable to display the advertisement using replacement (tool replacement time) of a consumable (a tool) approaching its lifetime as a trigger.

Similarly to the additional function advertisement, data (hereinafter, “advertisement display timing data”) related. to a timing (or a timing to suppress display of the advertisement) to display the advertisement may be set in advance so as to correspond to the advertisement of each consumable. By doing so, the advertisement, determination unit 132 to be described later can detect a consumable approaching its lifetime by referring to the consumable management information of the machine tool 100, for example, acquire a new product advertisement corresponding to the consumable approaching its lifetime by referring to the advertisement storage unit 122, and display the advertisement related to the consumable at an appropriate timing. When a follow-up product or a new product for the product is not present, the advertisement determination unit 132 may not select an advertisement related to the consumable.

Next, “(3) Advertisement related to operation efficiency improvement” will be described.

In this case, a case in which it is expected that a user (an operator) repeats machining of the machine tool 100 by modifying a program several times using the input unit 112 of the controller 110 will be described as an example.

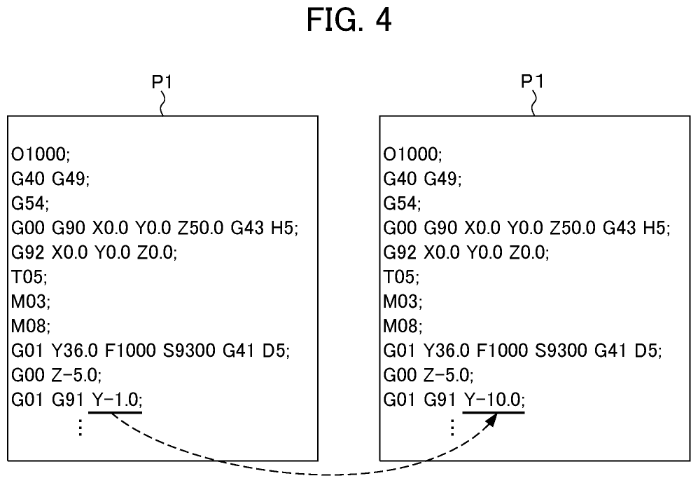

FIG. 4 is a diagram illustrating small-scale modification. of a program P1. As illustrated in FIG. 4, when it is determined that a user (an operator) makes small-scale modification several times to perform machining process using the machine tool 100 at each time, an advertisement that introduces a product (for example, a simulator) having a function of showing a machining path on a real-time basis is effective.

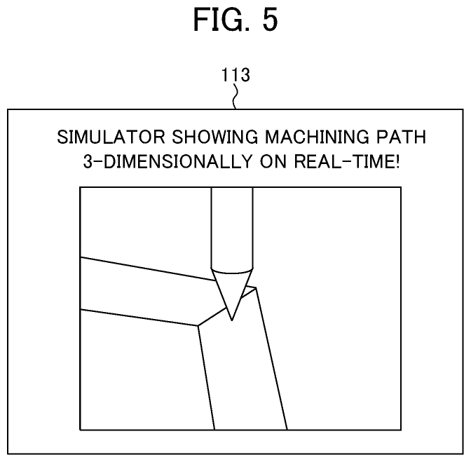

FIG. 5 is a diagram illustrating a simulator advertisement as an example of an advertisement related to operation efficiency improvement. As illustrated in FIG. 5 for example, by displaying a simulator advertisement on the display unit 113 of the controller 110, it is possible to appeal the usability of a simulator to an operator of the machine tool 100.

The advertisement display controller 120 determines a machining process unique to a user by acquiring an operation. history related to an operation in the machine tool 100 by referring to the storage unit 114 (the management storage area) of the machine tool 100, for example.

In this manner, the advertisement storage unit 122 can store an advertisement related to a function (a product) resulting in operation. efficiency improvement of a machining shape of the machine tool 100 in advance so as to correspond to the machining shape.

Moreover, as described above, data (advertisement display timing data) related to a timing (or a timing to suppress display of the advertisement) to display the advertisement may be set in advance in the advertisement storage unit 122 so as to correspond to the advertisement of a function (a product) resulting in operation efficiency improvement of each machining shape so that an advertisement related to operation efficiency improvement can be displayed at an appropriate timing.

Hereinabove, the features of advertisements stored in the advertisement storage unit 122 have been described.

In the above description, although a configuration in which the advertisement display controller 120 is provided in each machine tool 100 has been described, there is no limitation thereto.

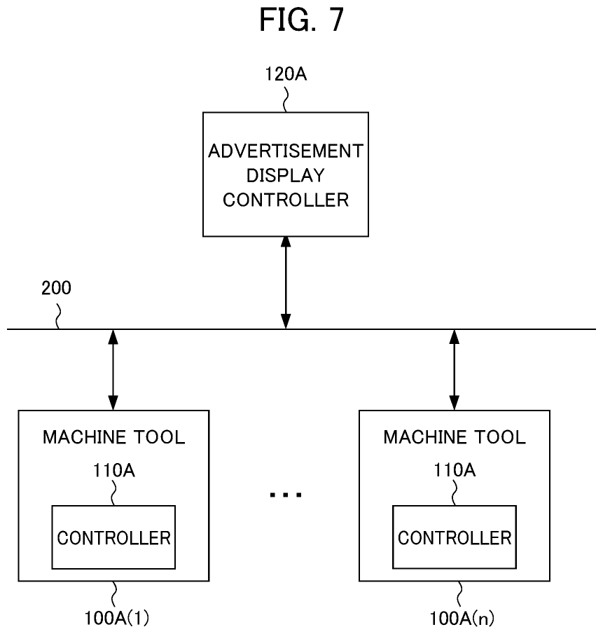

For example, the present invention can be applied to a case in which the advertisement display controller 120 as a server is communicably connected to a plurality of machine tools 100. FIG. 7 is a diagram illustrating an example of a case in which a plurality of machine tools 100 are communicably connected.

In this case, an advertisement storage area corresponding to each of the plurality of machine tools 100 may be provided in the advertisement storage unit 122, for example. Moreover, a common advertisement storage area may be provided for a common machine tool 100.

Next, the control unit 121 for displaying an advertisement stored in the advertisement storage unit 122 (that is, a display control function related to which and when an advertisement will be displayed) will be described.

### <Control Unit 121>

The control unit 121 has a CPU, a ROM, a RAM, a CMOS memory, and the like, which are communicably connected. via a bus, and well known to those skilled in the art, similarly to the control unit 111 of the controller 110 illustrated in FIG. 1.

The CPU is a processor that controls the entire advertisement display controller 120. The CPU reads a system program and an application program stored in the ROM via the bus and controls the entire advertisement display controller 120 according to the system program and the application program so that the control unit 121 realizes the functions (display control functions) of a state observation unit 130, a user operation determination unit 131, an advertisement determination unit 132, and an advertisement output unit 133 as illustrated in FIG. 1.

For example, the state observation unit 130 may observe the state of the machine tool 100 by acquiring a machining state, an operation history, and consumable management information (product information and use history information of each consumable) in the machine tool 100 by referring to the management storage area of the storage unit 114 of the controller 110 as described above.

More specifically, the state observation unit 130 can compare the cumulative tool use time of each tool (product) and a predetermined tool lifetime on the basis of the consumable management information ((product information and. use history information of each. consumable), for example, and observe whether the cumulative tool use time of each tool exceeds the tool lifetime. Similarly, the state observation unit 130 can observe whether a consumable (product) such as a coolant or a grindstone is approaching its lifetime by referring to the acquired consumable management information.

In this way, the state observation unit 130 can output the observation result to the advertisement determination unit 132 to be described later.

When it is determined, for example, that a user has modified the same machining program several times to test machining on the basis of an operation history of machining in the machine tool 100 acquired by the state observation unit 130, the user operation. determination unit 131 may determine that the user is debugging the machining program.

More specifically, when it is determined that a user (an operator) repeats machining of the machine tool 100 by modifying a program several times using the input unit 112 of the controller 110 on the basis of analysis of the operation history, the user operation determination unit 131 may determine that the user is debugging the program. In this case, the user operation. determination unit 131 may output the determination result to the advertisement determination unit 132 to be described later.

The advertisement determination unit 132 can select an advertisement including information useful to the user of the machine tool 100 on the basis of the observation result of the state observation unit 130 and the determination result of the user operation determination unit 131. Furthermore, the advertisement determination unit. 132 can determine a timing appropriate for distributing the selected advertisement on the basis of the advertisement display timing data for each advertisement set by the advertisement storage unit 122 and output the selected advertisement to the display control unit 1112 of the controller 110 via the advertisement output unit 133.

By doing so, the advertisement display controller 120 can suppress display of an advertisement so that an advertisement is not displayed at a timing at which it is expected that the importance of machining is high and a timing at which an operator performs a certain. operation related to machining, for example. In contrast, the advertisement display controller 120 can display an appropriate advertisement at a preparation timing, a tool replacement timing, a machining finishing step, or the like, for example.

Hereinafter, a specific description will be given according to the above-described classification.

### <(1) Additional Function Advertisement>

When the machine tool 100 has a tool tip point control function, for example, by combining additional functions such as a cutting point command function and a tool attitude control function, it is possible to improve the machining quality and shorten the machining time. Therefore, the advertisement determination unit 132 can select an advertisement capable of recommending an additional function that can provide more useful effects by being combined with the functions included in the machine tool 100 to a user from the advertisement storage unit 122.

The advertisement determination unit 132 may determine that a timing of displaying an advertisement during the use of the function, excluding a period in which a user such as an operator performs an operation (for example, a loading operation, a work checking operation, or the like) related to machining, for example, is an appropriate timing on the basis of the advertisement display timing data. The advertisement determination unit 132 can output the selected advertisement to the display control unit 1112 of the controller 110 via the advertisement output unit 133.

### <(2) Consumable Advertisement>

The advertisement determination unit 132 extracts a consumable (a product) of which the cumulative tool use time has exceeded a tool lifetime among the consumables such as tools, coolants, and grindstones observed by the state observation unit 130. The advertisement determination unit 132 can select an advertisement related to a follow-up product or a new product for the product on the basis of product information (for example, a model) of the extracted consumable (for example, a tool). When a follow-up product or a new product for the product is not present, the advertisement determination unit 132 may regard such a product as a non-advertisement target.

When an advertisement of a new product corresponding to a consumable approaching its lifetime, for example, is selected, the advertisement determination unit 132 may determine a timing before a period in which tool replacement is performed as an appropriate timing by taking a period related to placement of an order and delivery into consideration. The advertisement determination unit 132 can output the selected advertisement to the display control unit 1112 of the controller 110 via the advertisement output unit 133. The advertisement determination unit 132 may determine a timing to replace a consumable as an optimal timing.

Moreover, the advertisement determination unit 132 may output the selected advertisement to the display control unit 1112 of the controller 110 via the advertisement output unit 133 so that a one-touch operation function with which it is possible to easily place an order for an advertisement product in an advertisement screen.

### <(3) Advertisement Related to Operation Efficiency Improvement>

When the user operation determination unit 131 determines that a user is debugging a program, the advertisement determination unit 132 can select an advertisement that introduces a product (for example, a simulator) having a function of showing a machining path on a real-time basis. The advertisement determination unit 132 may determine a timing (or a timing to suppress display of the advertisement) to display the advertisement so as to correspond to the advertisement of a function (a product) resulting in operation efficiency improvement of each machining shape on the basis of the advertisement display timing data of the advertisement storage unit 122. The advertisement determination unit 132 can output the selected advertisement to the display control unit 1112 of the controller 110 via the advertisement output unit 133.

The advertisement determination unit 132 may select an advertisement appropriate for a machining state according to the machining state of the machine tool 100 without being limited to the three forms and may determine distribution (or stopping of the distribution of the advertisement) of the advertisement at an appropriate timing.

The advertisement determination unit 132 may select an advertisement so that a manufacturer of the machine tool 100 is the same as the manufacturer of a product on the basis of the information of the manufacturer included in the product information.

The advertisement output unit 133 may output the advertisement selected by the advertisement determination unit 132 to the controller 110 (the display control unit 1112).

### <Advertisement Display Process of Advertisement Display Controller 120>

Next, an operation related to the advertisement display process of the advertisement display controller 120 according to the present embodiment will be described.

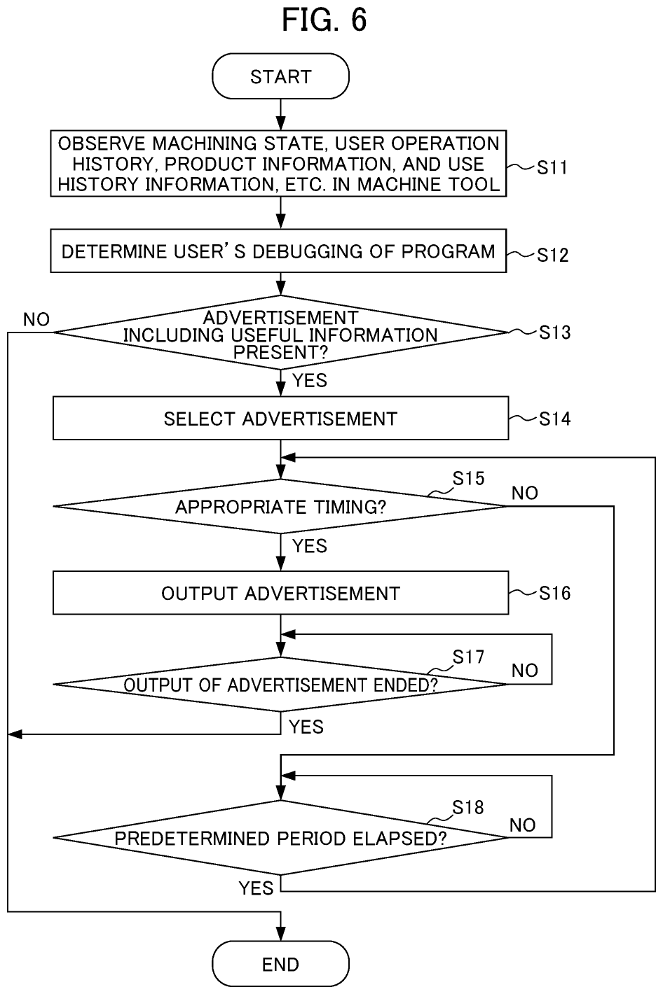

FIG. 6 is a flowchart for describing an advertisement display process of the advertisement display controller 120.

In step S11, the state observation unit 130 observes a machining state, a user's operation history, product information, use history information, and the like of the machine tool 100.

In step S12, the user operation determination unit 131 determines whether the user has debugged a program, for example, on the basis of the user's operation history acquired in step S11.

In step S13, the advertisement determination unit 132 determines whether there is an advertisement including information useful for the user of the machine tool 100 on the basis of the observation result in step S11 and the determination result in step S12. The process proceeds to step S14 when the advertisement is present and the flow ends when the advertisement is not present. When the advertisement is not present, the flow may proceed to step S11 after the elapse of a predetermined period. By doing so, it is possible to prevent. missing the timing to display an advertisement.

In step S14, the advertisement, determination unit 132 selects an advertisement from the advertisement storage unit 122 on the basis of the determination result in step S16.

In step S15, the advertisement, determination unit 132 determines whether the present time point is a timing appropriate for distributing the selected advertisement on the basis of the advertisement display timing data set in the advertisement storage unit 122. The process proceeds to step S16 when the present time point is an appropriate timing, and the process proceeds to step S18 when the present time point is not an appropriate timing.

In step S16, the advertisement output unit 133 outputs the advertisement selected in step S14 to the controller 110.

In step S17, the advertisement determination unit 132 determines whether the output of the advertisement has ended. The process ends when. the output of the advertisement has ended, and the process returns to step S17 when the output of the advertisement has not ended.

In step S18, the advertisement determination unit 132 determines whether a predetermined period has elapsed. The process proceeds to step S15 when the predetermined period has ended, and the process returns to step S18 when the predetermined period has not ended.

In this way, the advertisement display controller 120 of the embodiment acquires a machining state and an operation history related to machining in the machine tool 100 and the product information and the use history information about consumables (products) such as tools used by the machine tool 100. The advertisement display controller 120 selects an advertisement including information useful to the user according to an operation history and options of machining, and attributes related to “user's machining” such as a machining state and consumable (product) information on the basis of the acquired machining state, operation history, product information, and. use history information. In this way, the advertisement display controller 120 can provide an advertisement with a high appealing effect depending on the user associated with machining of the machine tool 100.

While an embodiment has been described, the advertisement display controller 120 is not limited to the above-described embodiment but includes modifications, improvements, and. the like within a range where the object of the present invention can be attained.

### <Modification 1>

In the above-described embodiment, although the advertisement display controller 120 is incorporated in the machine tool 100, the advertisement display controller 120 may be a device independent from the machine tool 100.

For example, as illustrated in FIG. 7, an advertisement display controller 120A is a server having the functions illustrated in FIG. 1, and may be configured as an advertisement distribution system that outputs (hereinafter also referred to as “distributes”) an advertisement to each of n machine tools 100A(1) to 100A(n) connected to a network 200 via the network 200. Here, n is an integer of 2 or more.

For example, an advertisement storage area corresponding to each of the machine tools 100A may be provided in the advertisement storage unit 122. Moreover, a common advertisement storage area may be provided for a common machine tool 100A.

The advertisement display controller 120A acquires the machining state and the operation history related to machining in the machine tool 100A and the product information and the use history information about the consumables (products) such as tools used by the machine tool 100 from each of the machine tools 100A. The advertisement display controller 120A selects an advertisement including information useful to the user according to attributes related to “machine tool” such as a machining state, the types, the versions of product numbers, and the manufacturer information of consumables (products) being used in each machine tool 100A on the basis of the acquired machining state, operation history, product information, and use history information. of each machine tool 100A. In this way, the advertisement display controller 120A can provide an advertisement with a high appealing effect depending on the machine tool 100A by determining a distribution destination machine tool 100A of the selected advertisement according to the attributes related to the “machine tool”.

Moreover, when the present invention is applied to the machine tool 100A used for a sharing service, a service provider can gain an advertisement revenue and can provide a service at a low cost. Moreover, a user who receives the service can receive the service at a low cost and obtain useful information.

Each of the machine tools 100A(1) to 100A(n) corresponds to the machine tool 100 in FIG. 1. The controllers 110A of the machine tools 100A(1) to 100A(n) correspond to the controller 110 in FIG. 1. The advertisement display controller 120A corresponds to the advertisement display controller 120 in FIG. 1.

### <Modification 2>

For example, in the above-described embodiment, although the advertisement display controller 120 has the functions of the state observation unit 130, the user operation determination unit 131, the advertisement determination unit 132, and the advertisement output unit 133, there is no limitation thereto.

For example, some or all of the functions of the advertisement display controller 120 may be realized using a virtual server function on the cloud, for example.

Furthermore, the advertisement display controller 120 may be a distributed processing system in which the functions of the advertisement display controller 120 are appropriately distributed to a plurality of servers.

### <Modification 3>

For example, in the above-described embodiment, although the controller 110 has the display unit 113 and displays a selected advertisement on the display unit 113, there is no limitation thereto. For example, an advertisement may be displayed on a monitor provided in the machine tool 100, a monitor, a mobile terminal, or the like provided near the machine tool 100.

### Modification 4>

For example, in the above-described embodiment, although the advertisement display controller 120 displays the selected advertisement on the display unit 113 of the controller 110, a purchase button for purchasing a product in the advertisement may be also displayed together with the advertisement. In this way, a user can purchase the product in the advertisement instantly and perform machining with higher quality.

The functions included in the advertisement display controller 120 according to the embodiment may be realized by hardware, software, or a combination thereof. Here, being realized by software means being realized when a computer reads and executes a program.

The programs can be stored on any of various types of non-transitory computer readable media and be provided to a computer. The non-transitory computer readable media include various types of tangible storage media. Examples of the non-transitory computer readable media include a magnetic recording medium (for example a flexible disk, a magnetic tape, and a hard disk drive), a magneto-optical recording medium (for example a magneto-optical disk), a CD-ROM (Read Only Memory), a CD-R, a CD-R/W, a semiconductor memory (for example a mask ROM, a PROM (Programmable ROM), an EPROM (Erasable PROM) , a flash ROM, and a RAM (Random Access Memory)). The programs may be provided to a computer by using any of various types of transitory computer readable media. Examples of the transitory computer readable media include electric signals, optical signals and electromagnetic waves. A transitory computer readable medium can provide programs to a computer through a wired communication path. such as an electrical cable, optical fiber, or the like or a wireless communication path.

Steps that describe a program recorded on a recording medium may include processes performed in a time-series manner according to the order thereof and may include processes executed in parallel or individually even if the processes are not necessarily processed in a time-series manner.

In other words, the advertisement display controller and. the advertisement distribution system of the present disclosure can employ various embodiments having the following configurations.

(1) An advertisement display controller 120 of the present disclosure is an advertisement display controller that outputs an advertisement of a product used by an industrial machine (a machine tool 100) to the industrial machine, including: an advertisement storage unit 122 that stores data indicating an advertisement of each of a plurality of products; a state observation unit 130 that observes a state of the industrial machine on the basis of at least a machining state of the industrial machine and a machining operation history of the industrial machine; an advertisement determination unit 132 that selects an advertisement including information useful for a user of the industrial machine on the basis of an observation. result of the state observation unit 130; and an advertisement output unit 133 that outputs the advertisement selected by the advertisement determination unit 132 to the industrial machine.

According to the advertisement display controller 120, it is possible to provide an advertisement with a high appealing effect depending on the use state of an industrial machine.

(2) The state observation unit 130 may observe whether a cumulative use time of the product has exceeded a lifetime of the product on the basis of consumable management information about the product used by the industrial machine.

By doing so, it is possible to select an advertisement of a product approaching its lifetime.

(3) The advertisement display controller may further include a user operation determination unit 131 that determines whether a program has been debugged on the basis of the operation history, and the advertisement determination unit 132 may select an advertisement including the useful information on the basis of a determination result of the user operation determination unit.

By doing so, it is possible to select an advertisement of a product helpful in debugging a program.

(4) The advertisement storage unit 122 may store at least advertisement display timing data that sets a timing to display an advertisement in advance so as to correspond to each of the plurality of advertisements, and the advertisement determination unit 132 may determine a timing to output the selected advertisement via the advertisement. output unit 133 on the basis of the advertisement display timing data.

By doing so, it is possible to display an advertisement at an appropriate timing that does not interrupt an operation of a user.

(5) The advertisement display timing data may set a timing to suppress display of an advertisement so as to correspond to each of the plurality of advertisements, and the advertisement determination unit 132 may temporarily stop the output of the advertisement when it is determined that a present time point is a timing to suppress display of the advertisement on the basis of the advertisement display timing data.

By doing so, since display of an advertisement is suppressed at a timing when a user performs an operation related to machining, it is possible to prevent a user's operation related to machining from being interfered.

(6) A server (an advertisement display controller 120A) of the present disclosure includes the advertisement display controller 120 according to any one of (1) to (5).

According to the server, it is possible to obtain the advantages similar to triose of any one of (1) to (5).

(7) An advertisement display control method of the present disclosure is an advertisement display control method for outputting an advertisement of a product used by an industrial machine (a machine tool 100) to the industrial machine, the method being realized by a computer and including: an advertisement storage step of storing data indicating an advertisement of each of a plurality of products; a state observation step of observing a state of the industrial machine on the basis of at least a machining state of the industrial machine and a machining operation history of the industrial machine; an advertisement determination step of selecting an advertisement including information useful for a user of the industrial machine on the basis of an observation result in the state observation step; and an advertisement output step of outputting the advertisement selected to the industrial machine.

According to the advertisement display control method, it is possible to obtain the advantages similar to those of (1).

### EXPLANATION OF REFERENCE NUMERALS

100: Machine tool

110: Controller

1112: Display control unit

120: Advertisement display controller

122: Advertisement storage unit

130: State observation unit

131: User operation determination unit

132: Advertisement determination unit

133: Advertisement output unit

What is claimed is:

1. An advertisement display controller that outputs an advertisement of a product used by an industrial machine to the industrial machine, comprising:
an advertisement storage unit that stores data indicating an advertisement of each of a plurality of products;
a state observation. unit that observes a state of the industrial machine on the basis of at least a machining state of the industrial machine and a machining operation history of the industrial machine;
an advertisement determination unit that selects an advertisement including information useful for a user of the industrial machine on the basis of an observation result of the state observation unit; and
an advertisement output unit that outputs the advertisement selected by the advertisement determination unit to the industrial machine.

2. The advertisement display controller according to claim 1, wherein the state observation unit observes whether a cumulative use time of the product has exceeded a lifetime of the product on the basis of consumable management information about the product used by the industrial machine.

3. The advertisement display controller according to claim 1, further comprising: a user operation determination unit that determines whether a program has been debugged on the basis of the operation. history, wherein
the advertisement determination unit selects an advertisement, including the useful information on the basis of a determination result of the user operation determination unit.

4. The advertisement display controller according to claim 1, wherein the advertisement storage unit stores at least advertisement display timing data that sets a timing to display an advertisement in advance so as to correspond to each of the plurality of advertisements, and
the advertisement determination unit determines a timing to output. the selected advertisement via the advertisement output unit on the basis of the advertisement display timing data.

5. The advertisement display controller according to claim 4, wherein the advertisement display timing data sets a timing to suppress display of an advertisement so as to correspond to each of the plurality of advertisements, and
the advertisement determination unit temporarily stops the output of the advertisement when it is determined that a present time point is a timing to suppress display of the advertisement on the basis of the advertisement display timing data.

6. A server including the advertisement display controller according to claim 1.

7. An advertisement display control method for outputting an advertisement of a product used by an industrial machine to the industrial machine, the method being realized by a computer and comprising:
as advertisement storage step of storing data indicating an advertisement of each of a plurality of products;
a state observation step of observing a state of the industrial machine on the basis of at least a machining state of the industrial machine and a machining operation history of the industrial machine;
an advertisement determination step of selecting an advertisement including information useful for a user of the industrial machine of the basis of an observation result in the state observation step; and
an advertisement output step of outputting the advertisement selected to the industrial machine.
